(19) United States
(12) Patent Application Publication
(10) Pub. No.: US 2019/0341209 A1
(43) Pub. Date: Nov. 7, 2019

(54) Electromechanical Relay With Test Button

(71) Applicant: Tyco Electronics EC Trutnov S.R.O., Trutnov (CZ)

(72) Inventors: Pavel Lev, Trutnov (CZ); Petr Kubu, Radvanive v Cechach (CZ); Petr Hofman, Batnovice (CZ); Jan Melisik, Nachod 1 (CZ)

(73) Assignee: Tyco Electronics EC Trutnov S.R.O., Trutnov (CZ)

(21) Appl. No.: 16/518,003

(22) Filed: Jul. 22, 2019

Related U.S. Application Data
(63) Continuation of application No. PCT/EP2018/051534, filed on Jan. 23, 2018.

(30) Foreign Application Priority Data
Jan. 23, 2017 (EP) 17152651.0

(51) Int. Cl. H01H 50/32; H01H 50/64

(52) U.S. Cl. CPC H01H 50/326; H01H 50/642

(57) ABSTRACT

An electromechanical relay comprises a contact assembly including a stationary contact and a movable contact, an electromagnetic actuator assembly actuating the movable contact, a housing encasing the contact assembly and the electromagnetic actuator assembly, and a test button that is rotatable and engages the actuator arm. The electromagnetic actuator assembly includes a coil assembly generating a magnetic field and an actuator arm that is movable to engage the movable contact and actuate the movable contact in response to the magnetic field. The actuator arm is slidable in a direction transverse to a longitudinal axis of the movable contact. The movable contact is manually operable from outside the housing by rotating the test button.

### CROSS-REFERENCE TO RELATED APPLICATIONS

This application is a continuation of PCT International Application No. PCT/EP2018/051534, filed on Jan. 23, 2018, which claims priority under 35 U.S.C. § 119 to European Patent Application No. 17152651.0, filed on Jan. 23, 2017.

### FIELD OF THE INVENTION

The present invention relates to an electromechanical relay and, more particularly, to testing of an electromechanical relay.

### BACKGROUND

Electromechanical relays are known in the art and generally comprise a contact assembly with at least one stationary contact and at least one movable contact. An electromagnetic actuator assembly comprises a coil assembly for generating a magnetic field and a movable armature that is attracted towards a core when the coil is energized. A movable actuator device is connected to the armature in order to actuate the movable contact in response to the magnetic field.

In order to test the correct functioning of the contact assembly and of any external electric circuitry connected to them, it is often desired to externally switch the contact assembly without electrically energizing the coil. However, known arrangements for manually actuating the contact assembly often have the disadvantage that they significantly increase the package dimensions of the relay. This is in particular disadvantageous for so-called slim net relays (SNR) which have to fit into mostly standardized small installation spaces.

### SUMMARY

An electromechanical relay comprises a contact assembly including a stationary contact and a movable contact, an electromagnetic actuator assembly actuating the movable contact, a housing encasing the contact assembly and the electromagnetic actuator assembly, and a test button that is rotatable and engages the actuator arm. The electromagnetic actuator assembly includes a coil assembly generating a magnetic field and an actuator arm that is movable to engage the movable contact and actuate the movable contact in response to the magnetic field. The actuator arm is slidable in a direction transverse to a longitudinal axis of the movable contact. The movable contact is manually operable from outside the housing by rotating the test button.

### BRIEF DESCRIPTION OF THE DRAWINGS

The invention will now be described by way of example with reference to the accompanying Figures, of which:

FIG. 1 is a perspective view of an electromechanical relay according to an embodiment in a normal operation mode;

FIG. 2 is a side view of the relay of FIG. 1;

FIG. 3 is a top view of the relay of FIG. 1;

FIG. 4 is a perspective view of the relay of FIG. 1 in a testing mode;

FIG. 5 is a side view of the relay of FIG. 4;

FIG. 6 is a top view of the relay of FIG. 4;

FIG. 7 is a schematic perspective view of an operation of a test button of the relay of FIG. 1;

FIG. 8 is a perspective view of the relay of FIG. 1;

FIG. 9 is a perspective view of an electromechanical relay according to another embodiment in a normal operation mode;

FIG. 10 is a side view of the relay of FIG. 9;

FIG. 11 is a top view of the relay of FIG. 9;

FIG. 12 is a perspective view of the relay of FIG. 9 without a housing;

FIG. 13 is a side view of the relay of FIG. 12;

FIG. 14 is a top view of the relay of FIG. 12;

FIG. 15 is a perspective view of the relay of FIG. 9 in a testing mode;

FIG. 16 is a side view of the relay of FIG. 15;

FIG. 17 is a top view of the relay of FIG. 15;

FIG. 18 is a perspective view of the relay of FIG. 15 without the housing;

FIG. 19 is a side view of the relay of FIG. 18; and

FIG. 20 is a top view of the relay of FIG. 18.

### DETAILED DESCRIPTION OF THE EMBODIMENT(S)

The accompanying drawings are incorporated into the specification and form a part of the specification to illustrate several embodiments of the present invention. These drawings, together with the description, serve to explain the principles of the invention. The drawings are merely for the purpose of illustrating the examples of how the invention can be made and used, and are not to be construed as limiting the invention to only the illustrated and described embodiments.

Furthermore, several aspects of the embodiments may form—individually or in different combinations—solutions according to the present invention. Further features and advantages will be become apparent from the following more particular description of the various embodiments of the invention as illustrated in the accompanying drawings, in which like references refer to like elements.

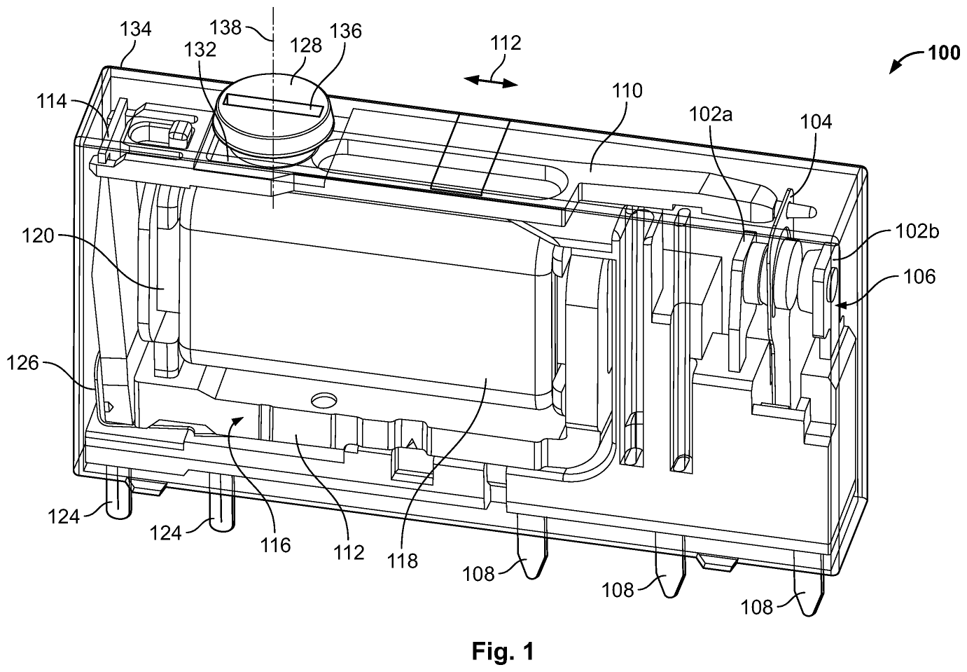

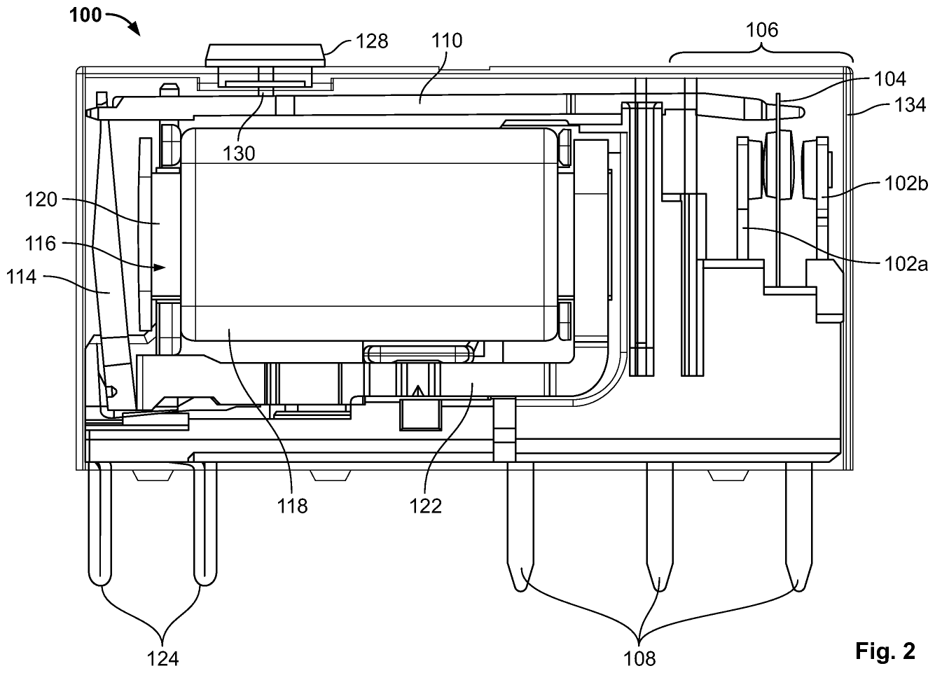

An electromechanical relay 100 according to an embodiment, as shown in FIGS. 1-3, comprises a contact assembly 106. The contact assembly 106 includes a movable contact 104 and two stationary contacts 102. Each of the contacts 104, 102 is connected to an external terminal 108. The external terminals 108, in an embodiment, are press-fit terminals that can be connected to a printed circuit board (PCB).

A protective housing 134, as shown in FIGS. 1-3, encloses an electromagnetic actuator assembly 116 and the contact assembly 106. In an embodiment, the protective housing 134 is fabricated from a plastic material.

The movable contact 104, as shown in FIGS. 1-3, is formed as a unilaterally fixed and resilient cantilever which is connected at its free end to an actuator arm 110. The actuator arm 110 is movable in a direction 112 transverse to a longitudinal axis of the movable contact 104. This movement causes a deflection of the movable contact 104 following the displacement of the actuator arm 110. Thereby, the electrical contact between a first stationary contact 102a and the movable contact 104 is opened and the electrical contact between a second stationary contact 102b and the movable contact 104 is closed.

In a regular operational mode, the actuator arm 110 is operated by the movement of an armature 114, shown in FIGS. 1-3. A first end of the actuator arm 110 is attached to the armature 114 and a second end of the actuator arm 110 is attached to the movable contact 104. The armature 114 is part of the electromagnetic actuator assembly 116 which further comprises a coil assembly including a coil 118, a core 120, and a yoke 122. Via coil terminals 124 an electrical current can be applied to the coil 118, thereby magnetizing the core 120 and the yoke 122. When the coil 118 is energized, the armature 114 is attracted towards the core 120 and the actuator arm 110 is moved in order to deflect the movable contact 104 from the first stationary contact 102a to the second stationary contact 102b.

A spring 126 forces the armature 114 into the position shown in FIG. 1 when the coil 118 is de-energized. Thus, the first stationary contact 102a is the normally closed contact.

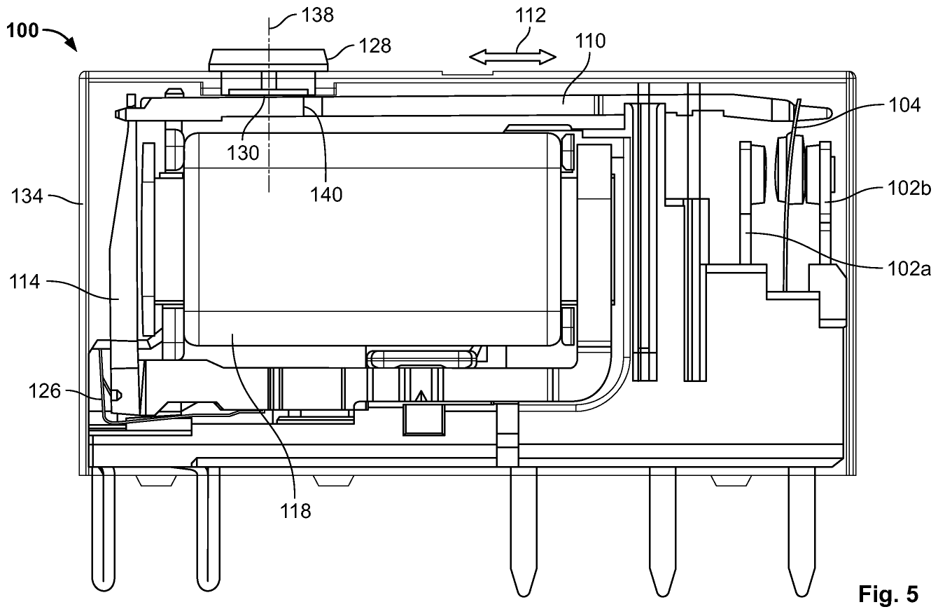

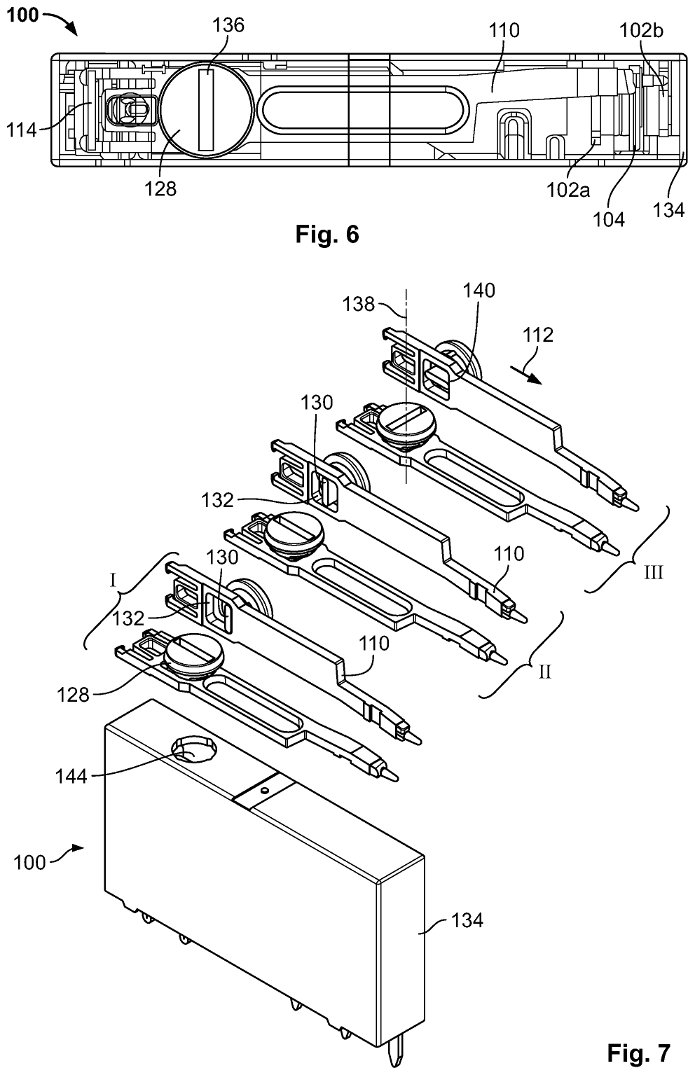

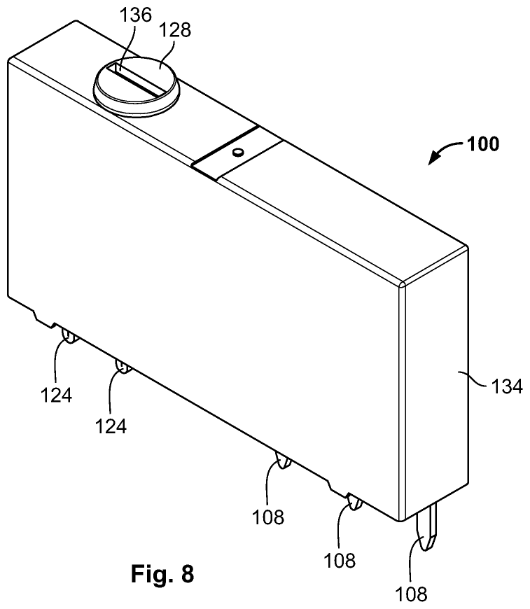

The relay 100, as shown in FIGS. 1-8, further comprises a test button 128. In a normal operational mode, the test button 128 is locked in an inactive rest position, shown in FIG. 1, where the movement of the actuator arm 110 is not hindered by the test button 128. The functioning of the test button 128 will be explained in more detail below with reference to FIG. 8. In an embodiment, the test button 128 and the actuator arm 110 are fabricated from a non-conductive plastic material. In other embodiments, the test button 128 and the actuator arm 110 may be made from other materials.

The test button 128 comprises a cam protrusion 130 that engages a guiding device of the actuator arm 110 to translate a rotational movement of the test button 128 into a linear movement of the actuator arm 110. As shown in FIGS. 1-3, the cam protrusion 130 extends through a rectangular, for example quadratic, cutout 132 provided at the actuator arm 110; the guiding device is formed by an edge of the cutout 132 . In the inactive position that is shown in FIGS. 1-3, the cam protrusion 130 is arranged within the cutout 132 in a way that it does not touch the edges of the cutout 132. Hence, the actuator arm 110 is freely movable for the regular electrical and magnetic actuation. FIG. 3 shows a top view of the relay 100 with the test button 128 in the inactive rest position. In another embodiment, a recess may be used instead of the cutout 132, wherein the recess does not reach through the complete thickness of the actuator arm 114, but is formed as a blind hole.

The test button 128 is accessible from outside the housing 134. The test button 128 has an operating recess 136 for turning the test button 128. In an embodiment, the operating recess 136 is formed as a slot into which a suitable tool (or a coin) can be inserted. The test button 128 is held in a notch of the housing 134 so that it is rotatable around a rotational axis 138. A longitudinal axis of the cam protrusion 130 includes 90° with the slot 136. In another embodiment, the test button 128 may have an outer contour that can be gripped by a matching tool or just manually by an operator; the outer contour of the button 128 may have the form of a nut, for example, a hexagonal nut.

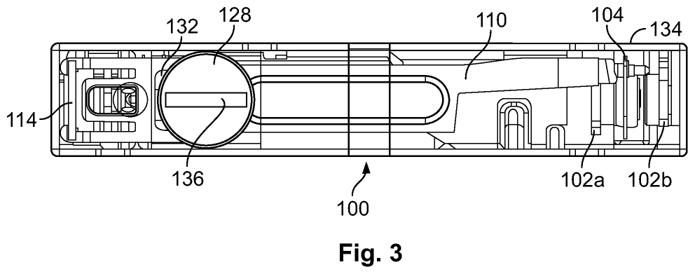

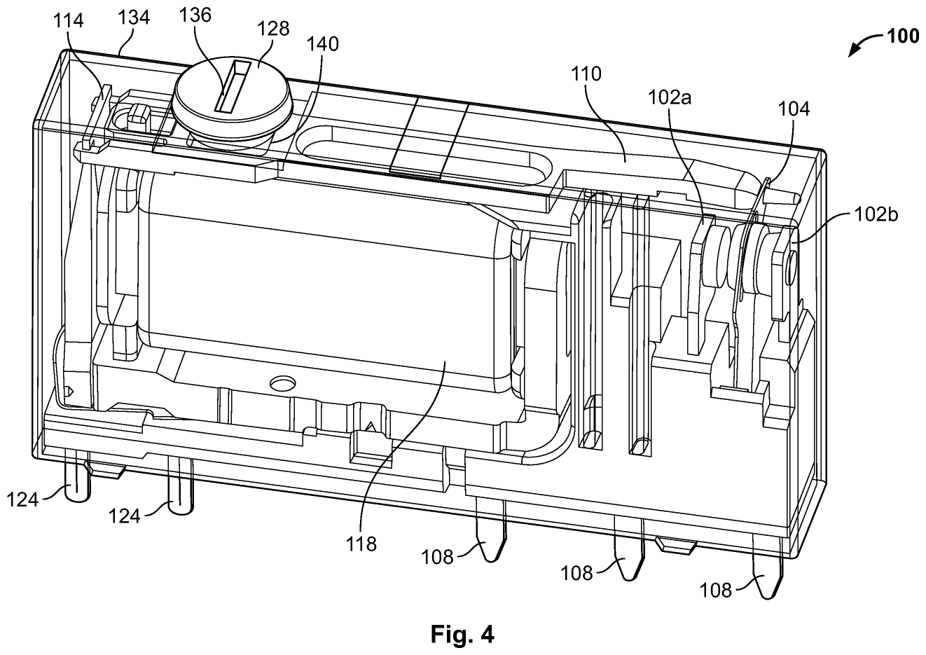

By turning the test button 128 through 90°, the second rest position, shown in FIGS. 4-6, is reached. In this position, the cam protrusion 130 interacts with a guiding wall 140 of the cutout 132 and pushes the actuator arm 110 towards the contact assembly 102. In an embodiment, the cutout 132 and the guiding wall 140 are arranged in a central region of the actuator arm 110 between a first end and a second end of the actuator arm 110. The movable contact 104 is thereby deflected to contact the second stationary contact 102b. In other words, the relay 100 is switched without energizing the coil 118. In this testing mode, the correct functioning of the relay 100 itself and/or any external electric circuitry connected thereto can be verified. A rotational movement of the test button 128 around the rotational axis 138 is transformed into a translational movement of the actuator arm 110 along the direction 112; only the minimal additional height of the test button 128 is added to the dimensions of the housing 134 which apart from that remains unchanged.

FIG. 7 shows an interaction between the test button 128 and the actuator arm 110. In positions I and II, the test button 128 is in the first rest position which was explained with reference to FIGS. 1-3. As shown in the bottom view of the actuator arm 110, the cam protrusion 113 has an elongated rectangular shape and extends through the essentially quadratic cutout 132 provided at the actuator arm 110.

Position I, shown in FIG. 7, depicts the situation where the relay 100 is not energized. The cam protrusion 130 is sized and arranged in a way that it does not hinder the movement of the actuator arm 110, so that the actuator arm 110 is retracted as far as to allow the movable contact 104 to be in connection with the first stationary contact 102a.

Position II, shown in FIG. 7, is assumed when the relay 100 is electromagnetically actuated by a current through the coil 118. As already mentioned above, the cam protrusion 130 does not hinder the movement of the actuator arm 110 because it does not block the arm's movement by extending inside the cutout 132.

By turning the test button 128 around the rotational axis 138, also the cam protrusion 130 is turned and engages with a guiding wall 140 being part of the cutout 132, shown in Position III in FIG. 7. This turning movement causes the actuator arm 110 to linearly move in the direction 112, thereby deflecting the movable contact 104 towards the second stationary contact 102b. In other words, by turning the test button 128 through 90°, a translational movement of the actuator arm 110 is caused that closes the contact between the movable contact 104 and the second stationary contact 102b without energizing the coil 118. Thus, a manual testing of any equipment that is connected to the relay can be performed without electrically energizing the relay 100. The relay 100 can also be permanently switched into the state where the electrical contact is established between the movable contact 104 and the second stationary contact 102b without energizing the coil 118.

In order to secure or lock the test button 128 in its rest positions, the test button 128 comprises snap-fit protrusions 142 which engage with corresponding recesses at the housing 134. In other embodiments, also any other suitable locking device may also be used for locking the test button 128 in the first and/or in the second rest position. The snap-fit protrusions 142, the operating recess 136, and the cam protrusion have rotational symmetry with respect to the rotational axis 138.

As shown in FIG. 8, the outer dimensions of the relay 100 are only minimally influenced by adding the test button 128. A height, in the shown embodiment, increases only by 0.8 mm due to the protruding external part of the test button 128. The test button 128 is arranged in an opening 144 provided at the housing 134 and shown in FIG. 7.

Although the description above always refers to the example of the relay 100 having one movable contact 104 and two stationary contacts 102, the idea according to the present invention is of course also usable with relays that have different contact configurations, for instance only one stationary contact or more than one movable contact.

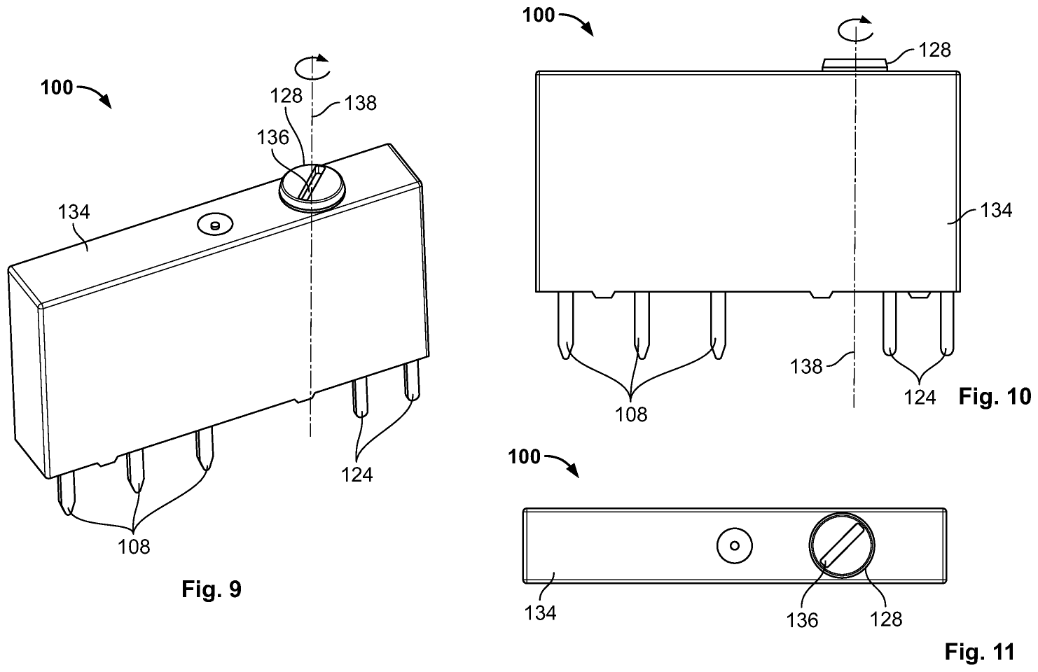

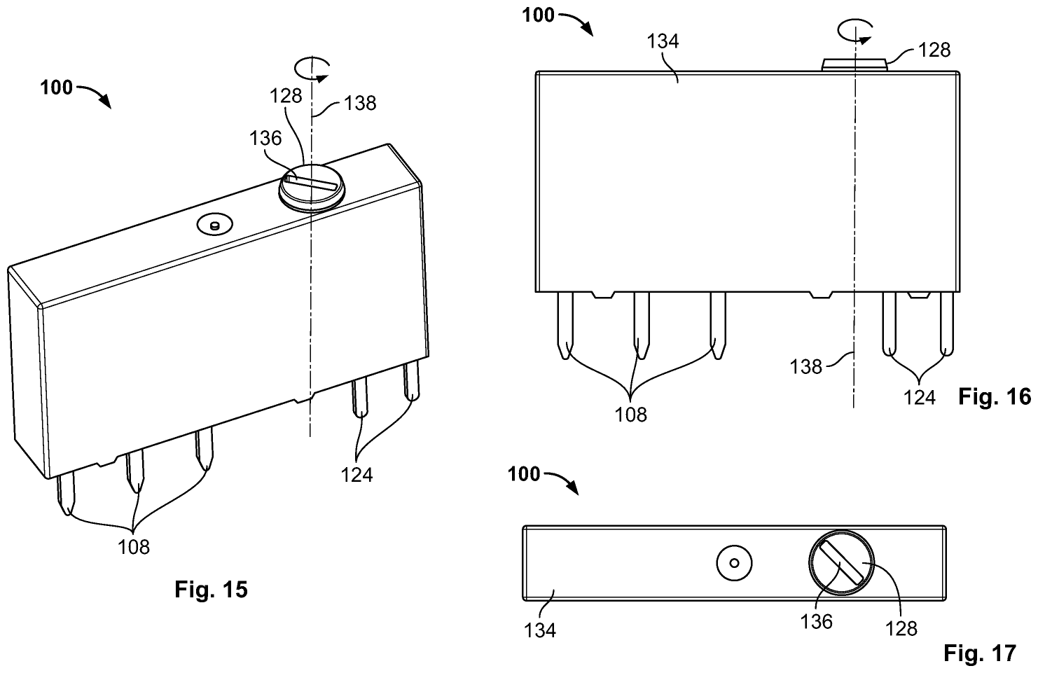

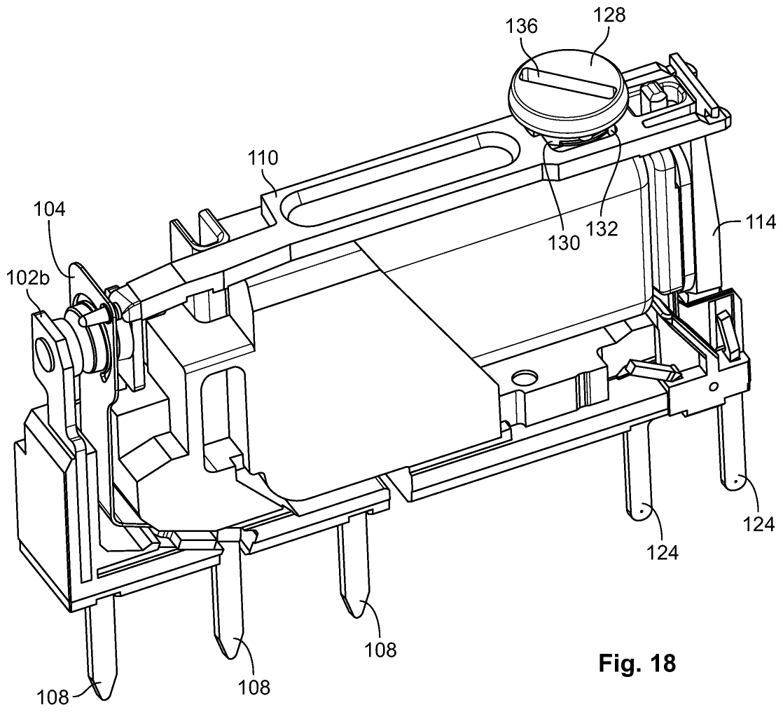

A relay 100 according to another embodiment is shown in FIGS. 9-20. In contrast to the design shown in FIGS. 1-8, in the relay 100 of FIGS. 9-20, the slot-shaped operating recess 136 of the test button 128 is arranged in a way that a user turns it through 90° from a first position including 45° with the longitudinal axis of the relay into a second position including 45° with the longitudinal axis. Consequently, a longitudinal axis of the cam protrusion 130 does not include 90° with the slot 136, as shown in FIG. 7, but 45°. Generally, the shape and orientation of the recess 136 can be chosen as needed for being operated by any desired tool shape. Apart from these modifications, the functioning of the relay 100 shown in FIGS. 9-20 is the same as explained above with reference to FIGS. 1-8.

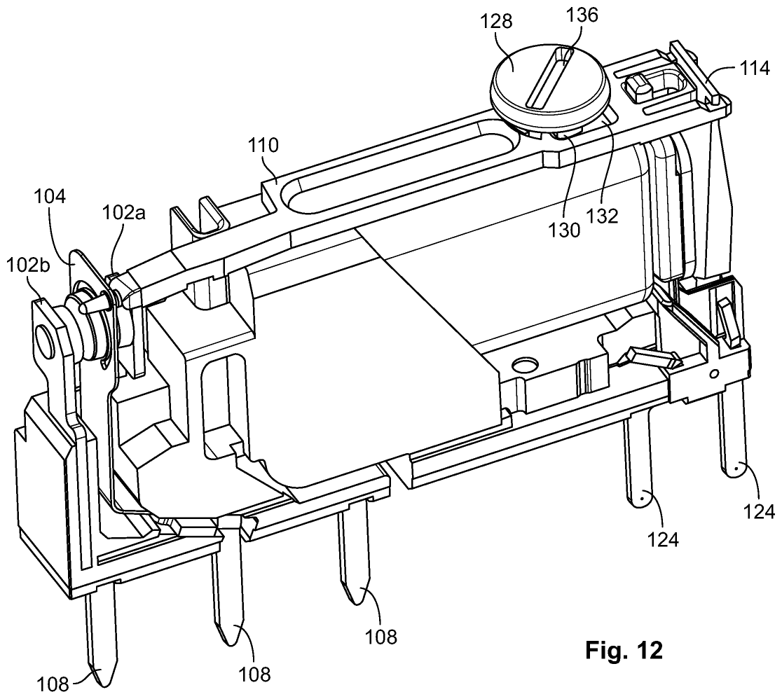

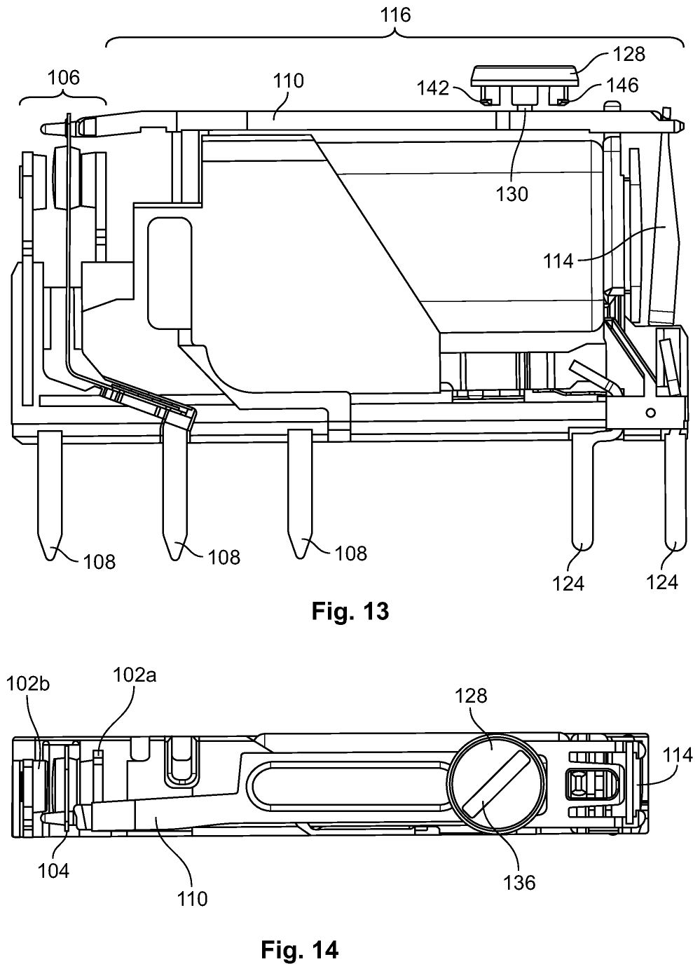

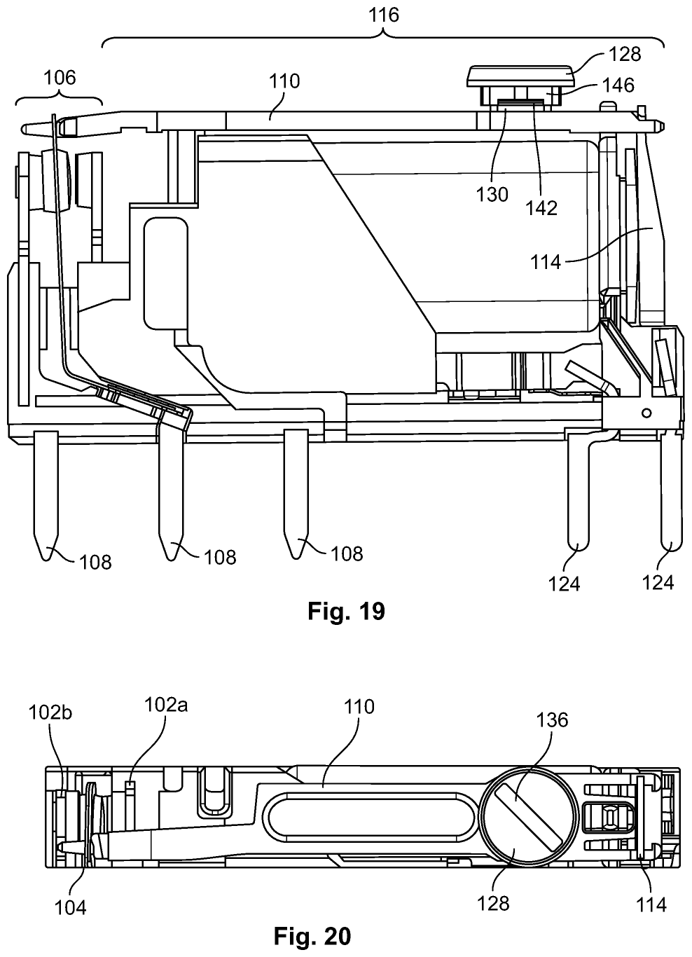

FIGS. 13 and 19 show a more detailed side view of the test button 128. As can 10 be seen from these drawings, the snap-fit protrusions 142 that lock the test button 128 in its rest positions at the housing 134 are formed at two opposing resilient spring arms 146. This resiliency facilitates moving the test button 128 out of one locked rest position into the other rest position. In the shown embodiment, the spring arms 146 have an arched shape and cover an angle of about 90° along the circumference of the circular outline of the test button 128. In other embodiments, the test button 128 may also have any other suitable design provided that the rotational movement of the test button 128 can be translated into a translational movement of the actuator arm 110, such as gear wheels or the like.

A method of testing the electromechanical relay 100 comprises the step of rotating the test button 128 around the axis 138 that extends transverse to the actuator arm 110, so that the test button 128 engages with the actuator arm 110 for operating the at least one movable contact 104 from outside the housing 134. By manually operating the movable contact 104 via the rotatable test button 128, the testing procedure is simple and can even be performed while the relay 110 is mounted on a printed circuit board (PCB) and/or in tight spaces. It is sufficient that only the test button 128 is accessible for a matching tool and that the test button 128 is rotatable.

What is claimed is:

1. An electromechanical relay, comprising:
a contact assembly including a stationary contact and a movable contact;
an electromagnetic actuator assembly actuating the movable contact, the electromagnetic actuator assembly including a coil assembly generating a magnetic field and an actuator arm that is movable to engage the movable contact and actuate the movable contact in response to the magnetic field, the actuator arm is slidable in a direction transverse to a longitudinal axis of the movable contact;
a housing encasing the contact assembly and the electromagnetic actuator assembly; and
a test button that is rotatable and engages the actuator arm, the movable contact is manually operable from outside the housing by rotating the test button.

2. The electromechanical relay of claim 1, wherein the test button has a cam protrusion that engages a guiding device of the actuator arm to translate a rotational movement of the test button into a linear movement of the actuator arm.

3. The electromechanical relay of claim 2, wherein the actuator arm has a cutout and the cam protrusion extends at least partly through the cutout, the guiding device is formed by an edge of the cutout.

4. The electromechanical relay of claim 1, wherein the test button has an operating recess accessible from outside the housing for turning the test button with a tool.

5. The electromechanical relay of claim 1, wherein the coil assembly has an armature magnetically actuated by a coil.

6. The electromechanical relay of claim 5, wherein a first end of the actuator arm is attached to the armature and a second end of the actuator arm is attached to the movable contact.

7. The electromechanical relay of claim 2, wherein the guiding device is arranged in a central region of the actuator arm between a first end and a second end of the actuator arm.

8. The electromechanical relay of claim 1, wherein the test button is operable between a first rest position and a second rest position, the actuator arm operates without engagement from the test button in the first rest position and the actuator arm engages the test button in the second rest position.

9. The electromechanical relay of claim 8, wherein the test button has a plurality of snap-fit protrusions adapted to lock the test button in at least one of the first rest position and the second rest position.

10. The electromechanical relay of claim 1, wherein the test button and/or the actuator arm are fabricated from a non-conductive plastic material.

11. The electromechanical relay of claim 1, wherein the contact assembly has a plurality of stationary contacts including a first stationary contact and a second stationary contact.

12. The electromechanical relay of claim 11, wherein the movable contact is biased against the first stationary contact in a non-energized state of the coil assembly.

13. The electromechanical relay of claim 12, wherein the actuator arm is movable by rotating the test button to establish an electrical connection between the movable contact and the second stationary contact.

14. The electromechanical relay of claim 1, wherein the movable contact is resilient and has a first fixed end and a second end opposite the first fixed end, the actuator arm engages the movable contact at the second end.

15. The electromechanical relay of claim 14, wherein a contact element for electrically contacting the stationary contact is arranged between the first fixed end and the second end of the movable contact.

16. A method of testing an electromechanical relay, comprising:
providing the electromechanical relay including a contact assembly having a stationary contact and a movable contact, an electromagnetic actuator assembly actuating the movable contact, the electromagnetic actuator assembly including a coil assembly generating a magnetic field and an actuator arm that is movable to engage the movable contact and actuate the movable contact in response to the magnetic field, the actuator arm is slidable in a direction transverse to a longitudinal axis of the movable contact, a housing encasing the contact assembly and the electromagnetic actuator assembly, and a test button; and
rotating the test button around an axis that extends transverse to the actuator arm so that the test button engages the actuator arm and operates the movable contact from outside the housing.

17. The method of claim 16, wherein, in the rotating step, a cam protrusion of the test button engages a guiding device of the actuator arm to translate a rotational movement of the test button into a linear movement of the actuator arm.

18. The method of claim 17, wherein the contact assembly has a plurality of stationary contacts including a first stationary contact and a second stationary contact.

19. The method of claim 18, wherein the movable contact is biased against the first stationary contact in a non-energized state of the coil assembly and, for testing the electromechanical relay, the actuator arm is movable by rotating the test button to establish an electrical connection between the movable contact and the second stationary contact.

20. The method of claim 16, wherein the test button is rotated between a first rest position and a second rest position by a rotation angle of 90°.
